(19) United States
(12) Patent Application Publication
(10) Pub. No.: US 2005/0278256 A1
(43) Pub. Date: Dec. 15, 2005

(54) System and method of promoting copy-managed digital content

(76) Inventors: Eric Vandewater, Scottsdale, AZ (US); Peter Jacobs, Phoenix, AZ (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/868,576

(22) Filed: Jun. 15, 2004

(51) Int. Cl. G06F 17/60

(52) U.S. Cl. 705/57

(57) ABSTRACT

A digital source of content such as a music album includes a storage media, which could be an optical disc such as the popular compact disc (CD) format for music albums or the digital versatile disc (DVD) format that is commonly used for consumer movie releases, and a digital work that is encoded in a digital format on the storage media. Information is advantageously encoded onto the storage media as well for enabling a copy management program on a personal computer to obtain advertising content that will be displayed on the personal computer. This information preferably includes a virtual address from which the advertising content may be retrieved, which could be a location on the storage media itself or an Internet address. The storage media further preferably includes an executable program for installing software on to the personal computer that may be used to play the digital work, monitor and report information that is relevant to the display of the advertising content to operators of the personal computer, and provide additional functionality such as copy management protection for the digital work.

### BACKGROUND OF THE INVENTION

1. Field of the Invention

This invention relates generally to the field of digital recordation and distribution of protected content of works such as audio compositions and video productions. More specifically, this invention relates to a system and method of protecting such digital content from unlawful copying and distribution by using a personal computer while further providing promotional opportunities to content providers and consumers.

2. Description of the Related Technology

The proliferation of personal computers and Internet access has permitted extensive unauthorized digital extraction, reproduction and distribution of a significant amount of artistic content, including audio, video, software, images and text. Significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards that are used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example, the standard MPEG Audio Layer 3 (MP3) format or Microsoft's Windows® Media (WMA) format are of good quality in comparison to prior analog copying approaches.

The music industry in particular has a strong interest in protecting its proprietary works from unauthorized copying and distribution, especially over the Internet or through other computer-based copying and distribution schemes that use music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable from the standpoint of the record labels, and of course their customers. When a consumer purchases a new CD he or she expects it to play in his or her equipment, and there is a great amount of anger and frustration if it does not. The record industry is extremely reluctant to take the risk of this happening to its end consumers who are appropriately purchasing its music offerings.

In addition, the reliability of protection against unauthorized copying and other digital extraction provided by the techniques that have been so far developed by the industry has been haphazard, being highly dependent upon specific hardware characteristics, firmware versions and countermeasures that have been employed by various forms of software. Another disadvantage of such technology is that it prevents a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player.®

The introduction of technology that is marketed by SunnComm International Inc. under the trademark MediaMax represented a significant advance in the field of copy protection for digital works. Using this technology, music files are provided in a compressed format, specifically a format that is subject to a digital rights management protocol, on a second Yellow Book data session of the CD. Software which is automatically loaded on to the personal computer from the CD when the CD is loaded into the CD/DVD drive of the computer will direct the computer user to the alternative content instead of to the CD-DA files that are contained in the first, Red Book session of the CD. This technology has met with commercial success and has proven to be effective. SunnComm also offers SecureBurn™ technology that permits computer users to make copy protected copies of their CDs, and PromoPlay™ technology that permits them to send their favorite songs to a friend.

Record labels spend a great deal of money promoting recording artists and their works. Traditionally, their marketing efforts have been directed toward broadcasters, the print media, record stores and, increasingly, Internet websites. While such marketing in no doubt effective, the industry is constantly seeking alternative ways to reach its consumers.

A need exists for an improved system and method for protecting digital content that does not adversely affect playability, that reliably prevents unauthorized duplication of digital content and that furthermore provides consumers an opportunity to play music that they have purchased on their personal computers. A need further exists for such a system and method that provides promotional content and opportunities to the consumer while he or she is using a personal computer to play the artistic content. Such a system should not consume excessive space on the digital media or carrier on which the digital content is contained, and should not require pre-installation of specific player software onto the personal computer.

### SUMMARY OF THE INVENTION

Accordingly, it is an object of the invention to provide an improved system and method for protecting digital content that does not adversely affect playability, that reliably prevents unauthorized duplication of digital content and that furthermore provides consumers an opportunity to play music that they have purchased on their personal computers.

It is further in object of the invention to provide such a system and method that allows promotional content and opportunities to be provided to the consumer while he or she is using a personal computer to play the artistic content.

It is yet further an object of the invention to provide such a system that would not consume excessive space on the digital media or carrier on which the digital content is contained, and should not require pre-installation of specific player software onto the personal computer.

In order to achieve the above and other objects of the invention, a digital source of content according to a first aspect of the invention includes a storage media; a digital work that is encoded in a digital format on the storage media; an executable copy management program on the storage media that is constructed and arranged to be executed by a personal computer; and advertising content on the storage medium that is configured to be accessed by the executable copy management program and displayed by a personal computer.

A digital source of content according to a second aspect of the invention includes a storage media; a digital work that is encoded in a digital format on the storage media; and information encoded on the storage media for enabling a copy management program on a personal computer to obtain advertising content to be displayed by the personal computer.

According to a third aspect of the invention, a method of operating a personal computer includes steps of accessing a work that is encoded in a digital format on a storage media with the personal computer; obtaining identification information from the storage media about the digital work; obtaining a virtual address from the storage media where advertising content may be obtained; retrieving the advertising content from the virtual address; and displaying the advertising content on the personal computer.

A method of doing business according to a fourth aspect of the invention includes steps of making a plurality of digital recordations of content, each of which includes a digital work encoded in a digital format on a storage media, the step of making digital recordations of content comprising encoding information on each of the storage media that is indicative of a virtual address from which advertising content may be obtained; providing a copy management program on said storage media that is constructed and arranged to present the advertising content to a user of an electronic device; and distributing the digital recordations of content to consumers.

According to a fifth aspect of the invention, a method of doing business includes steps of providing a digital recordation of content that has a digital work encoded in a digital format on a storage media in addition to information encoded on said storage media that is indicative of a virtual address from which advertising content may be obtained by an electronic device that is connected to the storage media; collecting data that relates to display of the advertising content to at least one user of the electronic device; and transmitting said collected data to an Internet server.

A method of marketing a creative work according to a sixth aspect of the invention includes steps of uploading advertising content relating to the creative work on an Internet web server; recording the creative work in digital format on a digital media; recording a copy management program on the digital media; recording a virtual address of the Internet web server on the digital media; distributing the digital media to a consumer; and updating the advertising content on the Internet web server.

According to a seventh aspect of the invention, a method of marketing copy management technology includes steps of operating an Internet web server; receiving content pertaining to a creative work via the Internet; receiving advertising content pertaining to the creative work via the Internet; and generating an image for a digital media distribution that includes said creative work, a virtual address of an advertising Internet web server and a copy management program. These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical depiction of a digital recordation of content that is constructed according to a preferred embodiment of the invention;

FIG. 2 is a diagrammatical depiction of a personal computer having a CD/DVD-ROM drive installed therein;

FIG. 3 is a schematic depiction of first and second sessions contained on a CD that is constructed according to the preferred embodiment of the invention;

FIG. 4 is a schematic diagram depicting operation of the administrative program that is constructed according to a preferred embodiment of the invention;

FIGS. 5A and 5B represent a logical flowchart depicting a process that is performed according to the preferred embodiment of the invention;

FIG. 6 is a logical flowchart depicting a second part of a process that is depicted in FIGS. 5A and 5B; and

FIG. 7 is a flowchart depicting a promotional aspect of the preferred embodiment of the invention.

### DETAILED DESCRIPTION OF THE PREFERRED EMBODIMENT(S)

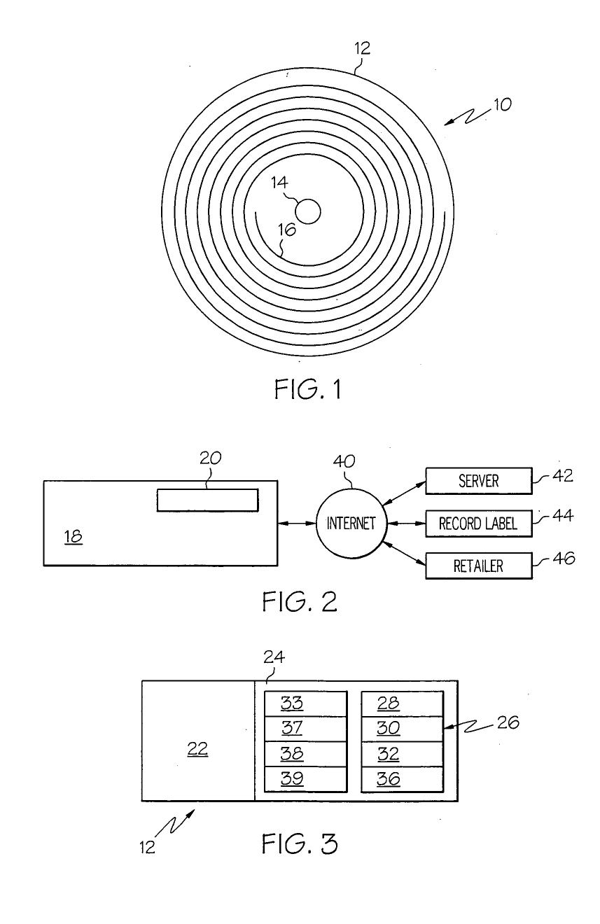

Referring now to the drawings, wherein like reference numerals designate corresponding structure throughout the views, and referring in particular to FIG. 1, a digital recordation of content on a storage media 10 that is constructed according to a preferred embodiment of the invention is preferably embodied as an optical disc, and more specifically in the preferred embodiment is a compact disc or CD 12 which, according to industry standard specifications, includes a center hole 14 and a continuous track 16 that is arranged in a helical pattern around the center hole 14. Information on a compact disc is recorded in a plurality of optically readable marks in a format that is specified by one or more industry standards. For example, data information is specified by what is commonly referred to as the Yellow Book standard, while audio information is provided a format that is specified by the Red Book standard. The information is typically pressed into the material from which the compact discs made, forming embossed pits and lands between the pits, each of which represents a single unit of binary or digital information.

Although in the preferred embodiment of the invention the digital recordation of content 10 is embodied as a compact disc, it should be understood that a digital recordation of content could alternatively take the form of a digital versatile disc or DVD, optical or magnetic digital tape, a hard drive, or any of a plurality of possible types of portable digital media, such as memory sticks, high-capacity magnetic storage cartridges or wireless remote storage options.

Shown schematically in FIG. 2 is a personal computer 18 that has installed therein a hardware device for reading the storage media 10. In the preferred embodiment, the hardware device is a CD/DVD-ROM drive 20 that is capable of reading information from the compact disc 12. Alternatively, the hardware device could be a DVD ROM drive, a magnetic or optical tape reader or any other type of hardware that is appropriate for reading the storage media 10 that may be selected within the broad scope of the invention.

Referring now to FIG. 3, it will be seen that the CD 12 contains a first session 22 that is preferably formatted according to the Red Book standard for digital audio. In other words, first session 22 contains a number of audio files that are in the CD-DA format. As is further shown in FIG. 3, CD 12 contains a second session 24 that is preferably formatted as a data session, according to the Yellow Book standard format. Second session 24 preferably includes an executable self extracting copy management utility file 26 that is constructed and arranged to preferably install at least five software programs on to the personal computer 18 when the CD 12 is inserted into the CD/DVD-ROM drive 20. For purposes of this document, a copy management program is defined as any executable program that is intended to prevent unrestricted access to protected content, or that is intended to implement software for such a purpose.

In a Windows™ operating environment, the file 37 that instructs the personal computer to automatically execute the executable self extracting copy management utility file 26 is typically an .inf file format, which will also be provided in the second session 24. The four programs that will be installed on to the personal computer by the self extracting utility file 26 include an administrative program 28, a conversion program 30, a secure player program 32, a user interface module 33 and a controlled copy program 36, the details of which will be described in greater detail below. These four programs perform separate distinct functions but could alternatively be combined in a single program performing all functions within the scope of the invention.

As is further shown in FIG. 2, personal computer 18 is preferably connected to the Internet 40, which also has connections to a web server 42, the purpose of which will be described in greater detail below. The Internet 40 is also connected to representatives 44 of a major record label and to the Internet web site 46 of a major consumer retailer.

Looking again to FIG. 3, it will be seen that the second session 24 further includes a virtual address informational file 38, which contains information that is readable by the secure player program 32 and that directs the secure player program 32 to a virtual address at which advertising content may be obtained by the secure player program 32. This virtual address may be located on the CD 12, such as in the second session 24, to a location that is in the personal computer 18, such as on the hard drive of the personal computer 18, or to an Internet address. In the preferred embodiment, the second session 24 further includes embedded advertising content 39 that may be utilized by the secure player program 32 when the advertising content at the virtual address is unavailable for some reason, such as disconnection of the personal computer 18 from the Internet 40.

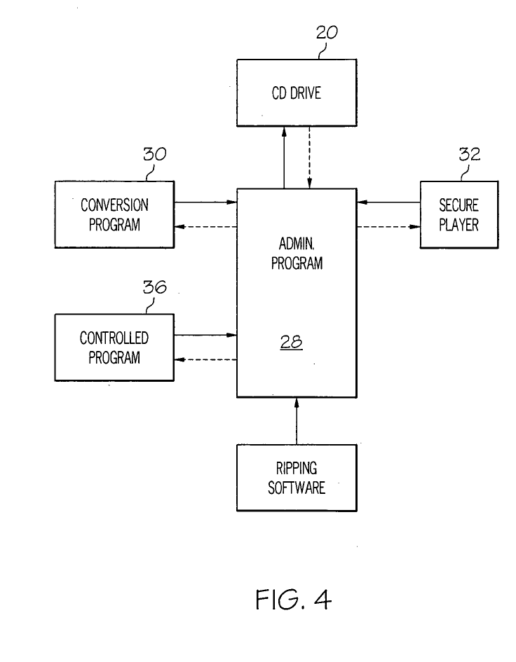

As is shown schematically in FIG. 4, the administrative program 28 once installed functions as a gatekeeper to information originating from the CD/DVD-ROM drive 20 including, of course, the protected content that is contained on the first session 22 of the CD 12. The administrative program 28 is in two-way communication with the CD/DVD-ROM drive 20 and is further configured to securely communicate with the conversion program 30, the secure player program 32 and the controlled copy program 36 that is constructed and arranged to permit a consumer to make a limited number of backup copies of the digital recordation of content. The details of the controlled copy program 36 are disclosed in PCT patent application PCT/US02/15972, the disclosure of which is hereby incorporated as if set forth fully herein.

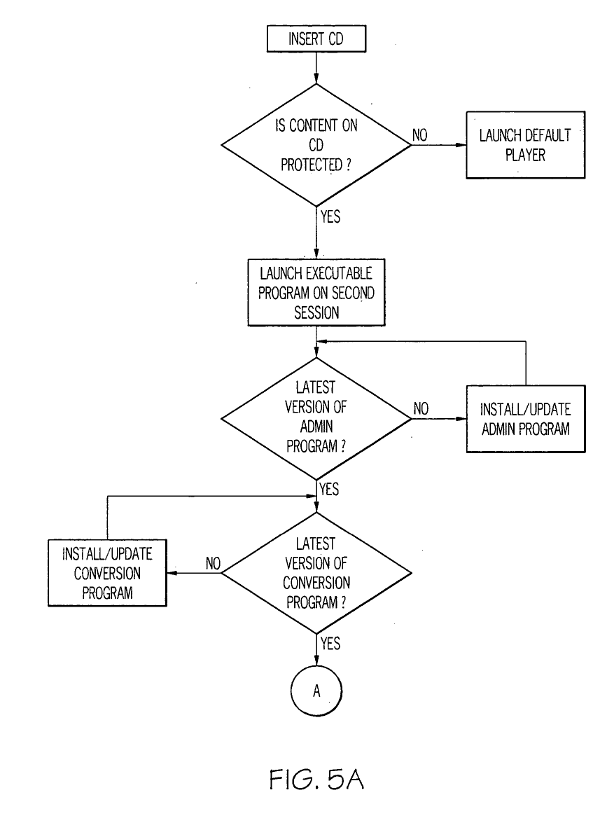

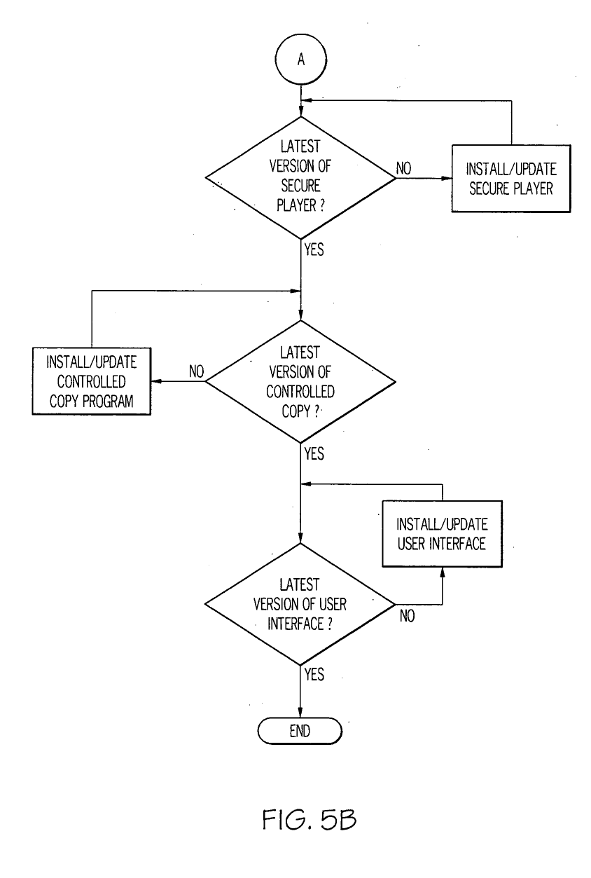

FIGS. 5A and 5B depict a process according to the preferred embodiment of the invention that is initiated with the insertion of a CD 12 into the CD/DVD-ROM drive 20 of the personal computer 18. If no data session is detected on the CD 12, the Windows operating system will launch the default software that is installed on the personal computer 18 for playing Red Book audio files. If, however, a data session according to the Yellow Book standard and configured according to the invention is detected on the CD 12 the Windows operating system will be instructed by the .inf file 37 that is located on the second session 24 to launch the self-extracting utility copy management program 26.

When launched, program 26 will first check to determine whether the latest version of the administrative program 28 is installed on the personal computer 18. If it is not, program 26 will install the latest version of the administrative program 28. After completion of this sequence, program 26 will determine whether the latest version of the conversion program 30 is installed on the personal computer 18 and will attend to installation of this program if it is not. Program 26 will then determine whether the latest version of the secure player program 32 is installed on the personal computer 18, and will insure as to its installation if it is not. Program 26 will then determine whether the latest version of the controlled copy program 36 is installed on the personal computer 18, and will insure as to its installation if it is not. Program 26 will then determine whether the latest version of the user interface module 33 is installed on the personal computer 18, and will ensure as to its installation if it is not. In the preferred embodiment of the invention, all of the necessary software for installing the administrative program 28, the conversion program 30, the secure player program 32 and the controlled copy program 36 is contained within the self extracting utility program 26 that is provided on the second session 24. Alternatively, however, if it is desired to make the program 26 more compact it would be equally within the scope of the invention to configure the utility program 26 to administer the downloading of the necessary software code from the Internet or to activate code that is already preinstalled on to the personal computer 18. It is further anticipated that as the invention gains market penetration one or more of the component programs such as the administrative program 28, the conversion program 30, the secure player program 32 and/or the controlled copy program 36 will be preinstalled on to the personal computer 18 as part of the OEM package, possible as part of the operating system.

After installation of the administrative program 28, the administrative program 28 will monitor the CD/DVD-ROM drive 20 and any additional CD/DVD-ROM drives to determine whether a digital recordation of content is present that contains content that is protected according to the invention. This may be done on a session by session basis or on an audio track by audio track basis, according to possible alternative embodiments of the invention. Preferably, the digital recordation of content is encoded to indicate whether or not content recorded thereon is protected. This coding may be embedded within the content files themselves (the CD-DA files in the case of an audio CD) or located elsewhere on the digital media such as in the table of contents, the lead-in area or the lead-out area. Alternatively, the presence of protected content on the compact disc 12 could be indicated to the personal computer 18 and specifically the administrative program 28 by any one of a number of different techniques, such as by searching for a particular file in the second data session, reviewing the size of a particular file, performing a check sum on a particular file or numbers of files, or looking for data within one or more particular files or within a predetermined sector or sectors. Specifically, a digital code could be added to the table of contents, to one of the P-W subchannels, to a reserved area on the Yellow Book session, or in the lead-out.

If the administrative program 28 determines that there is no protected content, the default player software may be launched by the operating system of the personal computer 18, and the content contained within the audio tracks of the CD 12 may be played normally without interference from the administrative program 28. In the embodiment of the invention where each audio track is checked for protected content, the default audio software may be permitted to access data from nonprotected tracks without interference from the administrative program 28 while data from protected tracks will be prevented from reaching the default audio software intact, as will be described in greater detail below.

Once protected content is detected on the digital recordation of content, the administrative program 28 will monitor the data stream between the hardware device in which the digital recordation of content is installed, which in the preferred embodiment is the CD/DVD-ROM drive 20, and any software application running on the personal computer 18 that may request information from the protected content. In the preferred embodiment, the administrative program 28 monitors the low-level SCSI command set instructions that are given to the CD/DVD-ROM drive 20. When a software application 34 such as those that are typically used to “rip” or create compressed digital audio files such as MP3s attempt to access the digital information that is contained on a protected audio track, the administrative program 28 will detect this request on the SCSI command level and, instead of returning the requested information will either not respond or return incorrect information to the software application. This incorrect information may be accurate information from a sector other than the sector from which the information was requested, completely random information, or the requested information upon which additional information has been superimposed. For example, the requested information could be returned with additional superimposed encoding that will have the effect of providing periodic unpleasant noises such as beeps or a prerecorded voice indicating that protected content is being requested. Preferably, the information that is returned by the administrative program 28 to the software application is returned in such a way that the software application will not be able to detect that anything other than the requested information has been provided. As a result, it will be difficult to employ effective countermeasures within the software application.

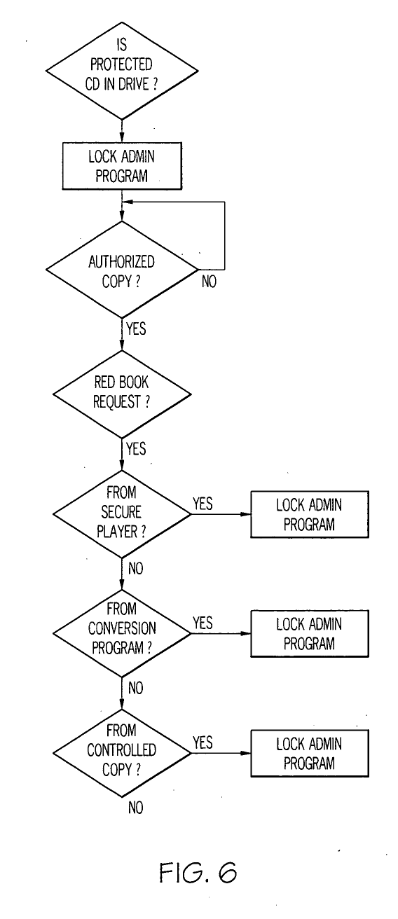

FIG. 6 is a logical flow diagram depicting a process that is performed according to the preferred embodiment of the invention upon loading of a CD 12 into a CD/DVD-ROM drive 20 of a personal computer 18 that has been configured according to the preferred embodiment of the invention. As described above, the administrative program 28 will continuously monitor data from the CD/DVD-ROM drive 22 in order to determine whether the CD 12 is protected according to the invention. Upon determination that there is protected content on the CD 12 the administrative program 28 will be cycled to what will be referred to as a locked condition, meaning that no unauthorized software program on the personal computer 18 will be permitted to access uncorrupted data from the CD/DVD-ROM drive 20. Certain authorized software programs will be permitted to access uncorrupted data from the CD/DVD-ROM drive 20, including the conversion program 30, the secure player program 32 and the controlled copy program 36. These authorized programs will be provided with an authorization code that will be recognized by the administrative program 28 as an instruction to grant access to the data from the CD/DVD-ROM drive 20. All data communication between the administrative program 28 and any authorized program is preferably encrypted so as to prevent the interception and utilization of this data by other software on the personal computer 18, such as software that could be developed by hackers for the express purpose of pirating the digital recordation of content that is contained on the CD 12. In the locked condition, the administrative program 28 will preferably deny access to software such as MP3 ripping software 34 or it will alternatively return corrupted information to such software that will frustrate efforts at unauthorized duplication of the digital work that is contained on the CD 12.

The administrative program 28 will then determine whether the CD 12 is an authorized copy such as an original stamped version of a compact disc or an unauthorized copy. This determination may be made in a number of different ways that are well known in this area of technology. The CD authentication mechanism is preferably either based on certain steps executed during the CD manufacturing process or on changes that are introduced by the supervisory program during the unauthorized copy process. For example, specific errors may be introduced on the disc during the CD replication process that can be detected by CDROM/DVD drives but not reproduced with regular CDROM/DVD burners. Alternatively, changes may be introduced in the sub-channels, to the CD-DA files, in the file structure on the second session, or by changing the content of certain files on the second session. If the CD 12 is determined to be an unauthorized copy the administrative program 28 will remain locked to all requests that are made to access to the protected content, i.e., the CD-DA files in the case of a Red Book standard audio CD.

As FIG. 6 shows, when the administrative program 28 detects a request that is made by a software program running on the personal computer 18 for access to the Red Book standard material (the CD-DA files) on the first session 22 of the CD 12 a determination is made whether the request is originating from the secure player software 32 and whether the authorization code is present. If the request is determined as originating from the secure player software 32 and the authorization code is determined to be present, the administrative program 28 will be unlocked for this request, but will remain locked in the event that simultaneous requests are made from unauthorized programs. The secure player program 32 will thus be permitted to play CD-quality audio track directly from the Red Book standard session without the need for conversion into a compressed format. This will provide the consumer with higher-quality audio than would be possible using compressed file formats.

If the request is not from the secure player program 32, the administrative program will determine whether or not the request is originating from the conversion program 30. If the request is determined to be originating from the conversion program 30 and if the necessary authorization code is present the administrative program 28 will be unlocked for this request, but will remain locked in the event that simultaneous requests is made from an unauthorized program or programs.

If the request is not from the conversion program 30, the administrative program will determine whether or not the request is originating from the controlled copy software 36. If the requested is determined to be originating from the controlled copy software 36 and if the necessary authorization code is present, the administrative program 28 will permit access by the controlled copy software 36 to the Red Book standard data.

In the preferred embodiment of the invention, the conversion program 30 and the secure player program 32 preferably share a user interface that will permit the computer user to either play music directly from the CD 12 using the secure player program 32 or to copy the music to the hard drive of the personal computer 18 using the conversion program 30. The conversion program 30 converts, on-the-fly, the Red Book audio files into a compressed file format that is governed by a digital rights management protocol that will control the terms on which the Red Book audio content may be used and will prevent effective sharing of these files between different personal computers. For example, the Microsoft® DRM protocol that is used according to the preferred embodiment of the invention permits a content provider to specify the (1) maximum number of allowed burns to CD; (2) the maximum number of allowed transfers to SDMI compliant portable devices; (3) the expiration of user rights by date; (4) the expiration of user rights by number of days; and (5) the expiration of user rights by number of plays. One important aspect of the invention is that by denying access to the protected content except through authorized programs, it enables the content provider to ensure that any use of the protected content by the consumer's personal computer will be governed by the content provider's own preferred DRM license conditions rather than those chosen by the consumer or provided by default by third-party software on the personal computer. For example, one recording artist or record company may desire to limit the number of permitted CD burns to a single backup copy of the CD, while another may choose more liberal terms. Broadly speaking, the invention permits a content provider to impose the selected license conditions upon the user of a personal computer as a direct consequence or result of the digital media bearing the protected content being inserted into the appropriate interface hardware of the personal computer. In the preferred embodiment, the specified DRM license conditions are encoded on the digital media together with the protected content and these license conditions are read, interpreted and enforced by those programs that are authorized to unlocked the administrative program 28. Alternatively, however, the specified DRM license conditions may be obtained from an alternative source subsequent to the insertion of the digital media bearing the protected content into the personal computer. For example, software and the personal computer might be configured to identify the specific audio CD that has been inserted into the CD/DVD-ROM Drive and download the applicable DRM license conditions from an Internet server.

Alternatively, it may be preferable to configure the conversion program 32 to enable it to specifically identify the audio tracks on the Red Book session and to download the alternative DRM file format to the personal computer 18 from the Internet rather than performing the processor intensive task of conversion. It is anticipated that this alternative embodiment of the invention will have greater utility in the future as the penetration of broadband Internet access to consumer households continues to increase.

In one embodiment of the invention, the administrative program 28 will maintain a log detailing relative information relating to requests that are received for access to information from the Red Book session from all software programs, authorized and unauthorized. This information may periodically be uploaded to a central server via the Internet for analysis. For example, it may be possible to detect the proliferation of hacker software that succeeds in counterfeiting the authorization code necessary to unlock the administrative program 28 and to take appropriate countermeasures in subsequent updates.

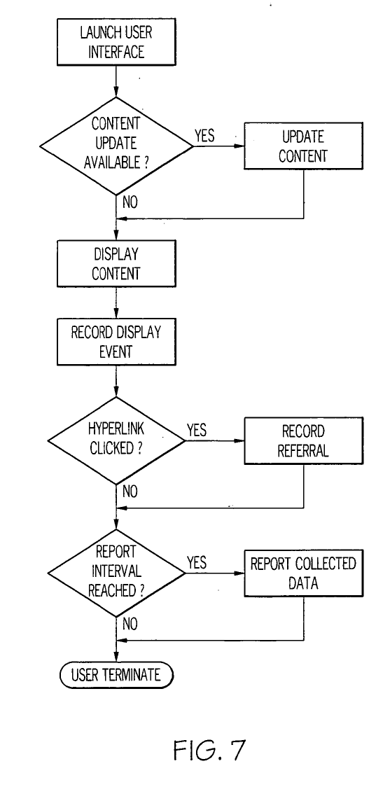

Referring now to FIG. 7, when a consumer inserts the CD 12 into the personal computer 18 and the updating procedures described above have been completed the user interface module 33 will be launched. The user interface module 33 will present the computer user with a number of different options, including an option to make licensed copies of the digital work for his or her personal computer 18. A second option presented will be to permit the computer user to listen to the digital work correctly using his or her personal computer. This would be accomplished by launching the secure player program 32. A third presented option would be to permit the computer user to use SunnComm's PromoPlay™ technology to send a song to a friend under controlled conditions. A fourth option would permit the computer user to surf the Internet web sites of the artist and the record label that produced the digital work. A fifth option would be to permit the computer user to make a copy protected copy of the digital work using SunnComm's SecureBurn™ technology.

As soon as the user interface module 33 is launched, it will retrieve the virtual address information from the informational file 38 that is located on the second session 24 of the CD 12. User interface module 33 will then attempt to retrieve updated advertising content from the specified virtual address. For purposes of this document, advertising is defined as including all communication from the artist, record label or third-party advertising agency to the consumer in relation to the digital work or the artist that created the digital work. This includes but is not limited to traditional advertising, consumer surveys, promotional offers and so forth. In the preferred embodiment of the invention, the virtual address is a uniform resource locator or URL that points to an Internet web server 42, shown in FIG. 2. In this embodiment, the user interface module 33 will first determine whether a live connection to the Internet is available, and if it is so available, will attempt to access the Internet web server 42. If updated content is found to be available on the web server 42, user interface module 33 will download it to the personal computer 18 and display the updated advertising content within a predetermined advertising template that is provided as part of the visible display of the user interface module 33. This predetermined advertising template is preferably communicated to the personal computer 18 via the informational file 38, and specifies such details as the size and position of the advertising window, the nature and the color of the graphical display and additional information as may be required. By providing this information in the informational file 38, Internet bandwidth is conserved. When updated advertising content is downloaded from the Internet web server 42, this information will be tailored to conform to the requirements of the template.

The informational file 38 preferably also includes information on the digital work such as the name of the artist, the number and titles of the individual tracks, the length of each track, copyright information, and so forth. Informational file 38 also includes a specific identifier that will be recognized by the Internet web server 42 and permit the Internet web server 42 to specifically identify the product release. In one embodiment of the invention, the specific identifier could also be specific to the retail establishment from which the digital work is purchased. For example, CDs that are shipped to Wal-Mart could potentially have a unique identifier, thereby permitting the Internet web server 42 to supply advertising to the personal computer user that is specific to that establishment. It is anticipated that the Internet web server 42 will update advertising content for each specific product release on a temporal basis, for example, every two months. The specific details will depend upon the business relationship between the operator of the Internet web server 42 and contracting advertisers.

Information provided by the Internet web server 42 may include the number of images to be displayed to the personal computer user, the images themselves, the amount of time for which each image is to be displayed on the personal computer and the Internet addresses that are targeted by active hyperlinks that may be contained within the respective images. In one embodiment of the invention, active HTML content may be provided for download by the Internet web server 42 in lieu of images.

If an Internet connection is not available, the default advertising content that is embedded within the second session 24 of the CD 12 will be displayed within the advertising template that is contained within the user display of the user interface module 33. Each time advertising content is displayed to the personal computer user, the display event is recorded by the user interface module 33. Preferably, the information recorded includes such details as the specific advertisement that was shown, the time for which it was shown in the activities that were performed by the computer user while it was being shown. For example, as the advertisement is being shown the computer user may decide to elect to use one of the different features described above, such as the SecureBurn™ option. In the preferred embodiment, each of the programs 28, 30, 32, 36 that are loaded onto the personal computer 18 from the second session 24 of the CD 12 has its own advertising display template window, so the display of the advertisement will not be diminished should the computer user avail his or herself of these options. Another possible embodiment would be giving the computer user the option to configure the desktop display of the personal computer with a background image that reflects the digital work or the recording artist. This desktop image background would be provided with a small advertising window in which the advertising content could be displayed.

In the preferred embodiment, the advertising displays are expected to contain one or more active hyperlinks that may be clicked upon by the computer user in order to establish a direct Internet connection to the advertiser. For example, a first hyperlink may be to the web site 44 of the record label, and a second hyperlink 46 may be to the retailer 46 from which the CD 12 was purchased. In the event that a hyperlink is clicked upon by the user, this event will be recorded by the user interface module 33.

The user interface module 33 will be provided with a predetermined reporting interval at which time the collected information will be reported to an Internet web server, which preferably although not necessarily is the Internet web server 42. This information may be used by the operator of the Internet web server 42 for such commercial purposes as determining invoicing amounts to the individual advertisers or providing quantitative marketing feedback to those customers or to potential advertisers. Advertisers could potentially be invoiced on a charge per view basis, or on a fee splitting basis in the case of referrals to the retailer web site. Additionally, user interface module 33 could be configured to permit the personal computer user to submit on a voluntary basis certain personal information that would also be compiled in reported to the Internet web server for marketing purposes.

In another possible embodiment of the invention, advertising could be provided that is specific to the individual song track that is being played at the time of the advertising display. In the case of a particularly popular song, computer users could be directed to web sites offering merchandise that is specific to that song or the subject matter to which the song relates.

According to one advantageous aspect of the invention, an Internet web server, which could although not necessarily be the same as the advertising Internet web server 42, may be maintained by a company marketing copy management technology according to the invention for the convenience of the record label customers. This Internet web server, shown schematically in FIG. 2, would include a record label interface that would permit the record label to upload the digital creative work that is to be marketed. In the case of an audio CD release, the Web interface would permit the record label to upload the CD-DA content that contains the audio information. The Web interface would further permit the record label to upload advertising content that is to be displayed using the advertising Internet web server 42. The copy management technology company would then generate a disc image that includes the audio files, the advertising content and a virtual address of the Internet web server 42. This disc image would then be downloaded by the record label or its designated CD replication facility, or could alternatively be provided manually to the CD replication facility by the copy management technology company.

After commercial release of the digital work the record label could periodically access the Internet web server to update the advertising content that is to be displayed to personal computer users as described above when the digital content is introduced to the personal computer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A digital source of content, comprising:
a portable digital storage media;
a digital work that is encoded in a digital format on said portable digital storage media;
an executable copy management program on said storage media that is constructed and arranged to be executed by a personal computer; and
advertising content on said storage medium that is configured to be accessed by said executable copy management program and displayed by a personal computer.

2. A digital source of content according to claim 1, wherein said storage media is an optical disc.

3. A digital source of content according to claim 1, wherein said executable copy management program is configured to load software onto hard drive of the personal computer.

4. A digital source of content according to claim 1, wherein said advertising content is related to said digital work.

5. A digital source of content according to claim 1, further comprising information encoded on said storage media that is indicative of a virtual address from which additional advertising content may be obtained.

6. A digital source of content according to claim 5, wherein said virtual address is an Internet address.

7. A digital source of content according to claim 1, wherein said executable copy management program is further constructed and arranged to load copy management software on to hard drive of the personal computer for playing the digital work on the personal computer.

8. A digital source of content according to claim 7, wherein said copy management software is further constructed and arranged to prevent access to the digital work by unauthorized programs that may be running on the personal computer.

9. A digital source of content, comprising:
a portable digital storage media
a digital work that is encoded in a digital format on said storage media; and
information encoded on said storage media for enabling a copy management program on a personal computer to obtain advertising content to be displayed by the personal computer.

10. A digital source of content according to claim 9, wherein said storage media is an optical disc.

11. A digital source of content according to claim 9, wherein said information includes a virtual address from which said advertising content may be located.

12. A digital source of content according to claim 11, wherein said virtual address comprises a location on said storage media.

13. A digital source of content according to claim 11, wherein said virtual address comprises an Internet address.

14. A digital source of content according to claim 9, wherein said storage media further has means encoded thereon for loading a player program on to the personal computer that is constructed and arranged to play said digital work on the personal computer.

15. A digital source of content according to claim 9, wherein said storage media further has means encoded thereon for loading a player program on to the personal computer that is constructed and arranged to play said digital work on the personal computer.

16. A digital source of content according to claim 15, wherein said player program is further constructed and arranged to utilize said information and to display said advertising content on the personal computer.

17. A digital source of content according to claim 9, wherein said storage media further has means encoded thereon for loading secure recording software on to the personal computer that is constructed and arranged to permit recordation of a copy protected version of said digital work.

18. A method of operating a personal computer, comprising:
accessing a work that is encoded in a digital format on a portable digital storage media with said personal computer;
obtaining identification information from said portable digital storage media about the digital work;
obtaining a virtual address from said portable digital storage media where advertising content may be obtained;
retrieving the advertising content from the virtual address; and
displaying the advertising content on the personal computer.

19. A method of operating a personal computer according to claim 18, wherein said storage media comprises an optical disc.

20. A method of operating a personal computer according to claim 18, wherein said identification information comprises the title of the digital work.

21. A method of operating a personal computer according to claim 18, wherein said identification information comprises the identity of the artist that created the digital work.

22. A method of operating a personal computer according to claim 18, wherein said virtual address identifies a location on said storage media from which advertising content may be obtained.

23. A method of operating a personal computer according to claim 18, wherein said virtual address identifies an Internet location from which advertising content may be located.

24. A method of operating a personal computer according to claim 18, further comprising a step of loading an anticopy program on to the personal computer from the said storage media.

25. A method of operating a personal computer according to claim 18, further comprising a step of loading a player program on to the personal computer from said storage media.

26. A method of operating a personal computer according to claim 18, further comprising a step of loading secure recording software onto the personal computer from said storage media that is constructed and arranged to permit recordation of a copy protected version of said digital work.

27. A method of doing business, comprising:
making a plurality of digital recordations of content, each of which includes a digital work encoded in a digital format on a storage media, said step of making digital recordations of content comprising encoding information on each of said storage media that is indicative of a virtual address from which advertising content to a user of electronic device; and
providing a copy management program on said storage media that is constructed and arranged to present the advertising content to a use of an electronic device; and
distributing the digital recordations of content to consumers.

28. A method of doing business according to claim 27, wherein said virtual address comprises a location on said storage media.

29. A method of doing business according to claim 27, wherein said virtual address comprises an Internet location.

30. A method of doing business according to claim 27, wherein said storage media comprises an optical disc.

31. A method of doing business according to claim 27, wherein said step of making a plurality of digital recordations of content further comprises encoding means on each of said storage media for installing at least one executable program on to a personal computer.

32. A method of doing business according to claim 31, wherein said executable program comprises an antipiracy program that is configured to limit access to said digital work by programs that may be running on the personal computer.

33. A method of doing business according to claim 31, wherein said executable program comprises a player program that is configured to play the digital work on the personal computer.

34. A method of doing business according to claim 33, wherein said player program is further constructed and arranged to retrieve said virtual address from said storage media.

35. A method of doing business according to claim 34, wherein said player program is further constructed and arranged to obtain advertising content from said virtual address.

36. A method of doing business according to claim 31, wherein said executable program comprises secure recording software that is constructed and arranged to permit recordation of a copy protected version of said digital work.

37. A method of doing business according to claim 27, further comprising monitoring information relating to display of the advertising content to users of the electronic device.

38. A method of doing business, comprising:
providing digital recordation of content that has a digital work and advertising content encoded in a digital format on a storage media, and has additional information encoded on said storage media that is indicative of a virtual address, such that an electronic device connected to such storage media can obtain advertising content on said storage media, as well as from a web or internet site associated with the virtual address;
collecting data that relates to display of the advertising content to at least one user of the electronic device; and
transmitting said collected data to an Internet server.

39. A method of doing business according to claim 38, wherein said step of collecting data comprises compiling the number of times that the advertising content has been displayed on the electronic device.

40. A method of doing business according to claim 38, wherein said advertising content contains at least one hyperlink to Internet content, and wherein said step of collecting data comprises collecting information relevant to utilization of said hyperlink by a user of the personal computer.

41. A method of doing business according to claim 38, wherein said storage media is an optical disc.

42. A method of doing business according to claim 41, wherein said digital recordation of content comprises a music CD.

43. A method of doing business according to claim 41, wherein said digital recordation of content comprises a video DVD.

44. A method of doing business according to claim 38, wherein said virtual address comprises a location on said storage media.

45. A method of doing business according to claim 38, wherein said virtual address comprises an Internet address.

46. A method of doing business according to claim 45, further comprising a step of changing advertising content that is available at said Internet address.

47. A method of doing business according to claim 45, wherein said Internet address is the Internet address of said Internet server.

48. A method of doing business according to claim 38, further comprising an advertising display template that is encoded onto said storage media, and wherein said advertising content is configured to provide information sufficient to operate said advertising display template on a personal computer.

49. A method of doing business according to claim 38, further comprising a step of collecting revenue as consideration for providing said advertising content.

50. A method of doing business according to claim 49, wherein said revenue is dependent on collected data.

51. A method of marketing a creative work, comprising steps of:
uploading advertising content relating to the creative work on an Internet web server;
recording the creative work in digital format on a digital media;
recording a copy management program on the digital media;
distributing the digital media to a consumer; and
updating the advertising content on the Internet web server.

52. A method of marketing a creative work according to claim 51, wherein said copy management program is constructed and arranged to display the advertising content on a personal computer.

53. A method of marketing a creative work according to claim 51, wherein said step of uploading advertising content is performed by a record label.

54. A method of marketing a creative work according to claim 53, wherein said step of updating advertising content is performed by a record label.

55. A method of marketing copy management technology, comprising steps of:
operating an Internet web server;
receiving content pertaining to creative work via the Internet;
receiving advertising content pertaining to the creative work via the Internet; and
generating an image for a digital media distribution that includes said creative work, a virtual address of an advertising Internet web server and a copy management program.

56. A method of marketing copy management technology according to claim 55, wherein said step of receiving content is performed by receiving the content from a record label.

57. A method of marketing copy management technology according to claim 55, wherein said step of receiving advertising content is performed by receiving said advertising content from a record label.

58. A method of marketing copy management technology according to claim 55, further comprising a step of receiving updated advertising content via the Internet after distribution of said digital media distribution to consumers.

59. A method of marketing copy management technology according to claim 55, wherein said Internet web server is the same as said advertising Internet web server.

60. A method of marketing copy management technology according to claim 55, wherein said image is a CD disc image.

61. A method of marketing copy management technology according to claim 60, further comprising a step of providing said CD disc image to a CD replication facility.

62. A digital source of content, comprising:
a portable digital storage media,
a digital work that is encoded in a Red Book digital format on said portable digital storage media;
an executable copy management program on said storage media that is constructed and arranged to be executed by a personal computer; and
advertising content on said storage medium that is configured to be accessed by said executable copy management program and displayed by the personal computer.

63. A digital source of content according to claim 62, wherein said storage media is CD disc.

64. A digital source of content according to claim 62, wherein said executable copy management program is configured to load software onto a hard drive of the personal computer.

65. A digital source of content according to claim 62, wherein said advertising content is related to said digital work.

66. A digital source of content according to claim 62, further comprising information encoded on said storage media that is indicative of a virtual address from which additional advertising content may be obtained.

67. A digital source of content according to claim 66, wherein said virtual address is an Internet address.

68. A digital source of content according to claim 62, wherein said executable copy management program is further constructed and arranged to load copy management software on to a hard drive of the personal computer for playing the digital work on the personal computer.

69. A digital source of content according to claim 68, wherein said copy management software is further constructed and arranged to prevent access to the digital work by unauthorized programs that may be running on the personal computer.

70. A digital source of content, comprising:
a portable digital storage media
a digital work that is encoded in a Red Book digital format on said storage media; and
information encoded on said storage media for enabling a copy management program on a personal computer to obtain advertising content to be displayed by the personal computer.

71. A digital source of content according to claim 70, wherein said storage media is a CD disc.

72. A digital source of content according to claim 70, wherein said information includes a virtual address from which said advertising content may be located.

73. A digital source of content according to claim 72, wherein said virtual address comprises a location on said storage media.

74. A digital source of content according to claim 72, wherein said virtual address comprises an Internet address.

75. A digital source of content according to claim 70, wherein said storage media further has means encoded thereon for loading a player program on to the personal computer that is constructed and arranged to play said digital work on the personal computer.

76. A digital source of content according to claim 75, wherein said player program is further constructed and arranged to utilize said information and to display said advertising content on the personal computer.

77. A digital source of content according to claim 70, wherein said storage media further has means encoded thereon for loading secure recording software on to the personal computer that is constructed and arranged to permit recordation of a copy protected version of said digital work.

78. A digital source of content comprising:
a portable digital storage media;
a digital work that is encoded in a digit format on said portable digital storage media;
a virtual address encoded on said storage media for enabling a copy management program on a personal computer to obtain advertising content from an internet server; and
an identifier encoded on said portable digital storage media that causes specific advertising content to be available from the internet server.

79. The digital source of content, according to claim 78, wherein said identifier can allow specific access to information pertaining to the digital work.

80. The digital source of content, according to claim 78, wherein said identifier can allow specific access to information pertaining to a retail establishment.

81. A method of operating a personal computer, comprising:
accessing a work that is encoded in a digital format on a portable digital storage media with the personal computer;
obtaining identification information from the portable digital storage media about the digital work;
obtaining a virtual address from the portable digital storage media wherein said virtual address is an Internet address from which advertising content may be obtained;
obtaining the advertising content from the virtual address wherein the identification information is transmitted to the Internet website to determine the specific advertising content which can be obtained; and
displaying the advertising content on the personal computer.
